(19) United States
(12) Patent Application Publication
(10) Pub. No.: US 2005/0178486 A1
(43) Pub. Date: Aug. 18, 2005

(54) Tire/wheel assembly

(76) Inventors: Kazuhiro Shimura, Hiratsuka-shi (JP); Takumi Sekiguchi, Hiratsuka-shi (JP); Mitsuru Naito, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/512,825

(22) PCT Filed: Jul. 29, 2003
(86) PCT No.: PCT/JP03/09594

(30) Foreign Application Priority Data
Jul. 30, 2002 (JP) 2002-220693

(51) Int. Cl. B60C 17/00

(52) U.S. Cl. 152/152

(57) ABSTRACT

A tire/wheel assembly, wherein a run-flat support body (3) comprising an annular shell (4) having an outer peripheral side as a support surface and an inner peripheral side formed in fork-shaped open legs and elastic rings (5) supporting the ends of the fork-shaped open legs on a rim is inserted into the hollow part of a pneumatic tire (2), and the height (A) of the run-flat support body (3) in the cross section thereof is 40 to 47% of the height (SH) of the pneumatic tire (2) in the cross section thereof.

### TECHNICAL FIELD

The present invention relates to a tire/wheel assembly, more specifically, to a tire/wheel assembly suppressing impact while driving in a run-flat state or with a lower pressured tire and having enhanced run-flat durability.

### BACKGROUND ART

Numerous techniques for achieving emergency running several hundred kilometers when a pneumatic tire blows out while driving a vehicle have been proposed to meet demands from the market. Among these numerous proposals, techniques disclosed in Japanese Unexamined Patent Publication No. 10(1998)-297226 and in Japanese Translation of PCT International Application No. 2001-519279 achieve run-flat driving by means of fitting a core onto a rim inside a hollow part of a pneumatic tire mounted on the rim, and by means of supporting the flat tire by the core.

The run-flat core (support body) has a configuration including an annular shell having an outer peripheral side as a support surface and an inner peripheral side formed in fork-shaped open legs with elastic rings fitted thereto. The run-flat core is supported on the rim through the elastic rings. This run-flat core is directly applicable to a conventional wheel/rim without special alteration, and therefore has an advantage that the run-flat core is acceptable to the market without causing confusion.

Mileage that the tire/wheel assembly (a wheel) can run flat in the event of a blowout of the tire depends on durability of the run-flat support body. The durability of the run-flat support body can be extended longer as an outside diameter is greater. However, although the inside diameter of the run-flat support body is equal to the inside diameter of a bead part of the pneumatic tire, the outside diameter of the run-flat support body is formed greater than the inside diameter of the bead part. Accordingly, the run-flat support body must be forcibly inserted into the pneumatic tire prior to mounting.

For this reason, if the outside diameter of the run-flat support body is too large, the excessive largeness not only makes it difficult for the run-flat support body to be inserted into the tire, but also amplifies impact received from road surfaces while driving in a run-flat state. In addition, extremely large impact is produced while running on protrusions such as cat's eyes when driving at a low pressure of about 130 kPa. Accordingly, for the run-flat support body, it has been deemed appropriate to have a height A in the cross section thereof which is equivalent to about one third of a height SH of the pneumatic tire in the cross section thereof.

### DISCLOSURE OF THE INVENTION

An object of the present invention is to provide a tire/wheel assembly which softens impact caused while running in a run-flat state or with a lower pressured tire, and which offers greater durability in the run-flat support body.

To attain the object, the present invention provides a tire/wheel assembly in which a run-flat support body including an annular shell having an outer peripheral side as a support surface and an inner peripheral side formed in fork-shaped open legs and elastic rings supporting the end parts of the fork-shaped open legs on a rim is inserted to into a hollow part of a pneumatic tire, wherein the height A of the run-flat support body in the cross section thereof is set at 40 to 47% of the height SH of the pneumatic tire in the cross section thereof.

With regard to a conventional tire/wheel assembly, in light of operability to insert the run-flat support body into the inside of the pneumatic tire, the height A of the run-flat support body in the cross section thereof is set to be equivalent to about one third (30 to 35%) of the height SH of the pneumatic tire in the cross section thereof. However, in the present invention, a lower limit of the height A in the cross section thereof is increased to be equal to, or greater than, 40% of the height SH of the pneumatic tire in the cross section thereof as described above. Accordingly, the durability of the run-flat support body while driving in a run-flat state is enhanced. Moreover, an upper limit of the height A of the run-flat support body in the cross section thereof is set to 47% of the height SH of the pneumatic tire in the cross section thereof Accordingly, it is possible to suppress impact at the moment of running on protrusions such as cat's eyes during low-pressure driving at about 130 kPa. Moreover, by defining the upper limit as described above, it is also possible to reduce impact while driving in a run-flat state.

In the present invention, it is more preferable that a difference B in a radial direction between an inside diameter end of the annular shell and an outside diameter end of a rim flange is set in a range from 5 to 15 mm. In this way, it is possible to achieve fine mounting performance after inserting the run-flat support body having the above-described height A in the cross section thereof into the pneumatic tire.

### BRIEF DESCRIPTION OF THE DRAWINGS

FIG. 1 is a meridional sectional view showing chief parts of a tire/wheel assembly according to an embodiment of the present invention.

FIG. 2 is a diagram of a run-flat support body set into a pneumatic tire.

### PREFERABLE MODES OF EMBODIMENT OF THE INVENTION

In the present invention, a run-flat support body is formed as an annular body to be inserted into a hollow part of a pneumatic tire. Of this run-flat support body, an outside diameter is formed smaller than an inside diameter of the hollow part so that a certain distance is maintained between the outside diameter and an inner surface of the hollow part of the pneumatic tire, and an inside diameter is formed as approximately the same dimension as an inside diameter of a bead part of the pneumatic tire. Moreover, this run-flat support body is mounted on a wheel together with the pneumatic tire while being inserted into the inside of the pneumatic tire, and is thereby formed into a tire/wheel assembly. When this tire/wheel assembly is fitted to a vehicle and the pneumatic tire blows out in a run, the tire, blown out and deflated, is supported by an outer peripheral surface of the run-flat support body, and thus run-flat driving can be achieved.

The run-flat support body includes an annular shell and elastic rings as chief parts.

The annular shell forms a continuous support surface on the outer peripheral side (the side of the outside diameter) for supporting the flat tire, and the inner peripheral side (the side of the inside diameter) thereof is formed with each side wall on the right and left shaped like one of the opened legs. A cross sectional shape in the orthogonal direction to the circumferential direction of the support surface on the outer edge is formed into a convex surface so as to protrude to the outside diameter. The number of convex portions on the outer edge of the annular shell may be one or more than one. However, when a plurality of convex portions are provided, it is possible to spread load for supporting during the run-flat driving over the plurality of convex portions. Accordingly, it is possible to enhance durability of the annular shell as a whole.

The elastic rings are respectively fitted to the end parts of both legs which are formed into the bifurcated shape towards the inside diameter of the annular shell. The elastic rings are in close contact with rim sheets on the right and left and thereby support the annular shell. The elastic ring is made of either rubber or elastic resin. In addition to buffering impacts and vibrations received by the annular shell from the flat tire, the elastic rings also have an antiskid function against the rim sheets so as to support the annular shell stably.

Since the run-flat support body of the present invention has to support a vehicle weight through the flat tire, the annular shell is made of a rigid material. Metal, resin, or the like is used as a constituent material thereof. Steel, aluminum or the like can be taken as an example about the metal herein. The resin may be either thermoplastic resin or thermosetting resin. The thermoplastic resin includes nylon, polyester, polyethylene, polypropylene, polystyrene, polyphenylene sulfide, ABS, and the like. Meanwhile, the thermosetting resin includes epoxy resin, unsaturated polyester resin, and the like. Although the resin can be used alone, it is also possible to blend reinforcing fibers and use the resin as fiber-reinforced resin.

Now, the present invention will be described concretely with reference to the accompanying drawings.

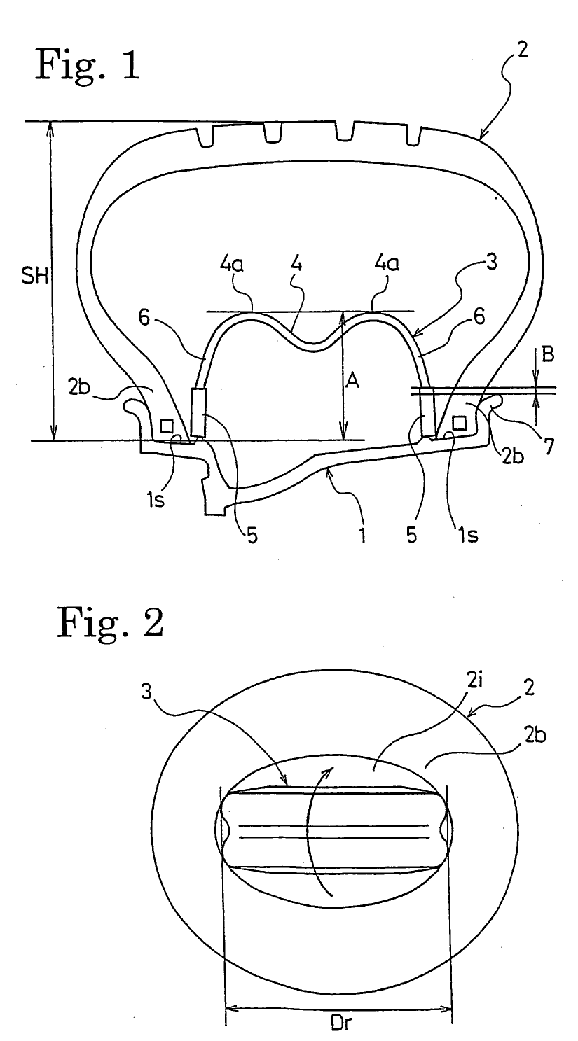

FIG. 1 is a cross sectional view in the width direction of the tire (a meridional sectional view) showing chief parts of a tire/wheel assembly (a wheel) according to an embodiment of the present invention.

Reference numeral 1 denotes a rim on an outer peripheral side of a wheel, reference numeral 2 denotes a pneumatic tire, and reference numeral 3 denotes a run-flat support body. The rim 1, the pneumatic tire 2, and the run-flat support body 3 are formed annularly around a shared axis with an unillustrated rotation axis of the wheel centered.

The run-flat support body 3 includes an annular shell 4 which is made of a rigid material such as metal or resin, and elastic rings 5 which are made of an elastic material such as hard rubber or elastic resin. The annular shell 4 includes convex portions 4a and 4a formed as two convex surfaces on the edge which are arranged in the width direction of the tire. Both side walls on the inner edge of this annular shell 4 are formed in fork-shaped open legs respectively as legs 6 and 6, and the elastic rings 5 and 5 are fitted to the ends thereof Regarding the run-flat support body 3 configured as described above, the elastic rings 5 and 5 along with bead parts 2b and 2b are fitted to rim sheets 1s and 1s of the rim 1 while being inserted into the pneumatic tire 2.

In the above-described configuration, the height A of the run-flat support body 3 in the cross section thereof (the height in the radial direction from the inner circumference to the outermost circumference) is formed in the size equivalent to 40 to 47% of the height SH of the pneumatic tire 2 in the cross section thereof (the height in the radial direction from the inner circumference of the bead part to an outer circumference of a tread). Durability of the run-flat support body 3 while driving in a run-flat state becomes higher as the outside diameter is greater. Accordingly, it is possible to enhance the run-flat durability by setting the lower limit of the height A of this run-flat support body in the cross section thereof to a high level of 40% of the height SH of the tire in the cross section thereof. However, if the height A of the run-flat support body in the cross section thereof exceeds 47% of the height SH of the tire in the cross section thereof, the impact which occurs in the event of running over protrusions such as cat's eyes is extremely increased while running with a low-pressured tire at about 130 kPa in particular, and comfortable riding is damaged. Moreover, the impact received from road surface is also increased while driving in a run-flat state.

When the run-flat support body 3 having a larger outside diameter Dr than the inner diameter of the bead part 2b of the pneumatic tire 2 is mounted as described above, the run-flat support body 3 is inserted into the inside of the pneumatic tire 2 in advance. FIG. 2 is a diagram of an operation of inserting the run-flat support body 3 into the pneumatic tire 2.

As shown in FIG. 2, firstly, the pneumatic tire 2 is placed horizontally, and the run-flat support body 3 is pushed into a position of a maximum diameter Dr of an inside circumferential part 2i of the bead part 2b thereof while the diametrical direction of the run-flat support body 3 is set upright. By pushing the run-flat support body 3 having the outside diameter Dr which is larger than the inside diameter of the bead part 2b of the pneumatic tire 2 into the inside diameter of the bead part as described above, the inside circumferential part 2i of the bead part 2b is transformed into an elliptical shape.

Subsequently, when the run-flat support body 3 is turned pivotally around the longitudinal axis direction of the ellipse from the state where the run-flat support body 3 is fitted as shown in the drawing and is thereby put horizontally, the run-flat support body 3 shares the rotation axis with the tire. Accordingly, the run-flat support body 3 is concentrically inserted into the pneumatic tire 2. Thereafter, the tire/wheel assembly can be assembled by mounting in accordance with the same operation for mounting a normal tire with a tire mounter.

Mounting operability after inserting the run-flat support body 3 set to the height A in the cross section thereof as described above into the pneumatic tire 2 depends on a difference B in the radial direction of the run-flat support body between an inside diameter end of the annular shell 4 and an outside end of a rim flange 7. Accordingly, it is preferable that the difference B in the radial direction is set in a range from 5 to 15 mm. The mounting operation is not easy if the difference B in the radial direction is below 5 mm. On the other hand, a radial dimension (a cross sectional dimension) of the annular shell 4 is reduced and the durability of the run-flat support body 3 is thereby reduced if the difference B in the radial direction is excessive. Therefore, the difference B should be limited to 15 mm.

In the present invention, the sizes of the pneumatic tire and the rim used for the tire/wheel assembly are not particularly limited. Although the tire/wheel assembly of the present invention is applicable to a passenger car, a bus or a truck, it is particularly preferred for use in a passenger car.

As described above, according to the present invention, it is possible to enhance the durability of the ran-flat support body while driving in a run-flat state by increasing the lower limit of the height A of the run-flat support body in the cross section thereof to equal to or greater than 40% of the height SH of the tire in the cross section thereof. Moreover, it is possible to suppress impact in the event of running over protrusions such as cat's eyes while driving with a low-pressured tire. In addition, impact while driving in a run-flat state is suppressed by setting the upper limit of the height A of the run-flat support body in the cross section thereof to 47% of the height SH of the tire in the cross section thereof.

### EXAMPLES

With 205/55R16 and 16×6 1/2JJ designated respectively as common tire size and rim size, and with the difference B in the radial direction between the inside diameter of the annular shell of the run-flat support body and the outside diameter of the rim flange set at 5 mm in common, seven types of tire/wheel assemblies (which are a conventional example, comparative examples 1 to 3, and examples 1 to 3) having various ratios of the height A of the run-flat support body in the cross section thereof relative to the height SH of the tire in the cross section thereof were manufactured.

Regarding these seven types of tire/wheel assemblies, the run-flat durability, low-pressure impacts and run-flat impact were measured in accordance to the measurement method described below. Results are shown in Table 1.

[Run-Flat Durability]

Each tire/wheel assembly for testing was fitted to the left front side of a passenger car of 2500 cc displacement with a tire pressure set at 0. Meanwhile, the tire pressure for the other tires was set at 200 kPa. Then, a test driver drove the car around a circuit track at 90 km/h until the run-flat support body broke down, and the mileage at that point was measured. Evaluation is indicated with an index where the mileage measured by use of the conventional tire/wheel assembly is taken as 100. Accordingly, a larger index represents superior run-flat durability.

[Low-Pressure Impact]

The tire pressure of the testing car used for the above-described running test for the run-flat durability was set at a low pressure of 130 kPa, and impacts received at the moment of running over cat's eyes having the height of 50 mm at speed of 90 km/h were evaluated in the light of comfortable riding. The evaluation was performed as follows. A case of a tolerable degree of impact was indicated by ◯, and a case of extremely large impact that is intolerable for an average person was indicated by X.

[Run-Flat Impact]

Impacts received from a road surface were concurrently evaluated in the light of comfortable riding during the running test for the run-flat durability. The evaluation was performed as follows. A case of a tolerable degree of impact was indicated by ◯, and a case of extremely large impact that is intolerable for a long period was indicated by X.

TABLE 1

| | | | | Run-flat |
|---|---|---|---|---|
| | A/SH | Low-pressure | Run-flat | durability |
| | (%) | Impact | Impact | (index) |
| Conventional | 30 | ◯ | ◯ | 100 |
| Example | | | | |
| Comparative | 35 | ◯ | ◯ | 105 |
| Example 1 | | | | |
| Example 1 | 40 | ◯ | ◯ | 120 |
| Example 2 | 45 | ◯ | ◯ | 125 |
| Example 3 | 47 | ◯ | ◯ | 128 |
| Comparative | 50 | X | ◯ | 130 |
| Example 2 | | | | |
| Comparative | 55 | X | X | 135 |
| Example 3 | | | | |

1. A tire/wheel assembly in which a run-flat support body including an annular shell having an outer peripheral side as a support surface and an inner peripheral side formed in fork-shaped open legs and elastic rings supporting the ends of the fork-shaped open legs on a rim is inserted into a hollow part of a pneumatic tire,
wherein a height A of the run-flat support body in the cross section thereof is set at 40 to 47% of a height SH of the pneumatic tire in the cross section thereof.

2. The tire/wheel assembly according to claim 1,
wherein a difference B in the radial direction of the run-flat support body between an inside diameter of the annular shell and an outside diameter of a rim flange is set in a range from 5 to 15 mm.

3. The tire/wheel assembly according to claim 1,
wherein the annular shell is made of either metal or resin, and
the elastic rings are made of either rubber or elastic resin.

4. The tire/wheel assembly according to claim 2,
wherein the annular shell is made of either metal or resin, and
the elastic rings are made of either rubber or elastic resin.
